(19) United States
(12) Patent Application Publication
(10) Pub. No.: US 2026/0129002 A1
(43) Pub. Date: May 7, 2026

(54) METHODS AND APPARATUS FOR AI/ML TRAFFIC DETECTION

(71) Applicant: SAMSUNG ELECTRONICS CO., LTD., Suwon-si, Gyeonggi-do (KR)

(72) Inventors: Tingyu XIN, Staines (GB); David Gutierrez ESTEVEZ, Staines (GB); Mahmoud WATFA, Staines (GB)

(21) Appl. No.: 19/117,373

(22) PCT Filed: Sep. 25, 2023
(86) PCT No.: PCT/KR2023/014699

§ 371 Date: Mar. 31, 2025

(30) Foreign Application Priority Data
Sep. 30, 2022 (GB) 2214434.9
Aug. 29, 2023 (GB) 2313114.7

(51) Int. Cl. H04L 47/80; H04L 43/0852

(52) U.S. Cl. CPC H04L 47/801; H04L 43/0852; H04L 47/805

(57) ABSTRACT

The disclosure relates to a 5G or 6G communication system for supporting a higher data transmission rate. There is disclosed a first network entity included in a communication network, the first network entity comprising: a transmitter; a receiver; and a controller configured to: monitor traffic from a second network entity included in the communications network; and based on the traffic being associated with a type of an artificial intelligence/machine learning (AI/ML) operation, perform one or more operations to assist performance of the AI/ML operation.

### TECHNICAL FIELD

Various embodiments of the present disclosure relate to methods, apparatus and/or systems for detecting artificial intelligence/machine learning (AI/ML) traffic. In particular, various embodiments of the present disclosure provide methods, apparatus and systems for determining, by a user plane function (UPF) or any 5GS network function (NF), that traffic from a user equipment (UE) or application will be or is associated with an AI/ML operation. Further, various embodiments of the present disclosure provide different methods for making this determination and/or performing one or more operations to assist the AI/ML operation. Further, in various embodiments of the present disclosure, information regarding the result of the determination is transmitted to a session management function (SMF) or any 5GS NF. Further, in various embodiments of the present disclosure, the NFs (or network entities) are included in a 3rd Generation Partnership Project (3GPP) 5th Generation (5G) New Radio (NR) communications network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In AI/ML (artificial intelligence/machine learning) operation, AI/ML models and/or data might be transferred across the AI/ML applications (application functions (AFs)), 5GC (5G core) and UEs (user equipments). The AI/ML works could be divided into two main phases: model training and inference. During model training and inference, multiple rounds of interaction may be required. The high volume and frequent transmitted AI/ML traffic will increase the challenges for the 5GC to handle the traffic (including both AI/ML and other existing traffic).

In Section 6.40 AI/ML model transfer in 5GS TS 22.261, three types of AI/ML operations to be supported in Release 18 are described as follows:

### AI/ML Operation Splitting Between AI/ML Endpoints

The AI/ML operation/model is split into multiple parts according to the current task and environment. The intention is to offload the computation-intensive, energy-intensive parts to network endpoints, whereas leave the privacy-sensitive and delay-sensitive parts at the end device. The device executes the operation/model up to a specific part/layer and then sends the intermediate data to the network endpoint. The network endpoint executes the remaining parts/layers and feeds the inference results back to the device.

### AI/ML Model/Data Distribution and Sharing Over 5G System

Multi-functional mobile terminals might need to switch the AI/ML model in response to task and environment variations. The condition of adaptive model selection is that the models to be selected are available for the mobile device. However, given the fact that the AI/ML models are becoming increasingly diverse, and with the limited storage resource in a UE, it can be determined to not pre-load all candidate AI/ML models on-board. Online model distribution (i.e. new model downloading) is needed, in which an AI/ML model can be distributed from a NW (network) endpoint to the devices when they need it to adapt to the changed AI/ML tasks and environments. For this purpose, the model performance at the UE needs to be monitored constantly.

### Distributed/Federated Learning Over 5G System

The cloud server trains a global model by aggregating local models partially-trained by each end devices. Within each training iteration, a UE performs the training based on the model downloaded from the AI server using the local training data. Then the UE reports the interim training results to the cloud server via 5G UL channels. The server aggregates the interim training results from the UEs and updates the global model. The updated global model is then distributed back to the UEs and the UEs can perform the training for the next iteration.

### DISCLOSURE OF INVENTION

### Solution to Problem

In accordance with another aspect of the present disclosure, there is provided a method of a first network entity included in a communications network, the method comprising: monitoring traffic from a second network entity included in the communications network; and based on the data being associated with a type of an artificial intelligence/machine learning (AI/ML) operation, performing one or more operations to assist performance of the AI/ML operation.

In accordance with an aspect of the present disclosure, there is provided a first network entity included in a communication network, the first network entity comprising: a transmitter; a receiver; and a controller configured to: monitor traffic from a second network entity included in the communications network; and based on the data being associated with a type of an artificial intelligence/machine learning (AI/ML) operation, perform one or more operations to assist performance of the AI/ML operation.

Before undertaking the Mode for Invention below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF DRAWINGS

A more complete appreciation of the disclosure and many of the attendant aspects thereof will be readily obtained as the same becomes better understood by reference to the following detailed description when considered in connection with the accompanying drawings, wherein:

FIG. 1 illustrates a representation of a call flow according various embodiments of the present disclosure;

FIG. 2 illustrates a representation of a call flow according to various embodiments of the present disclosure;

FIG. 3 illustrates an example structure of a network entity in accordance with various embodiments of the present disclosure;

FIG. 4 illustrates a flow diagram of a method according to various embodiments of the present disclosure;

FIG. 5 illustrates a flow diagram of a method according to various embodiments of the present disclosure; and

FIG. 6 illustrates a flow diagram of a method according to various embodiments of the present disclosure.

### MODE FOR THE INVENTION

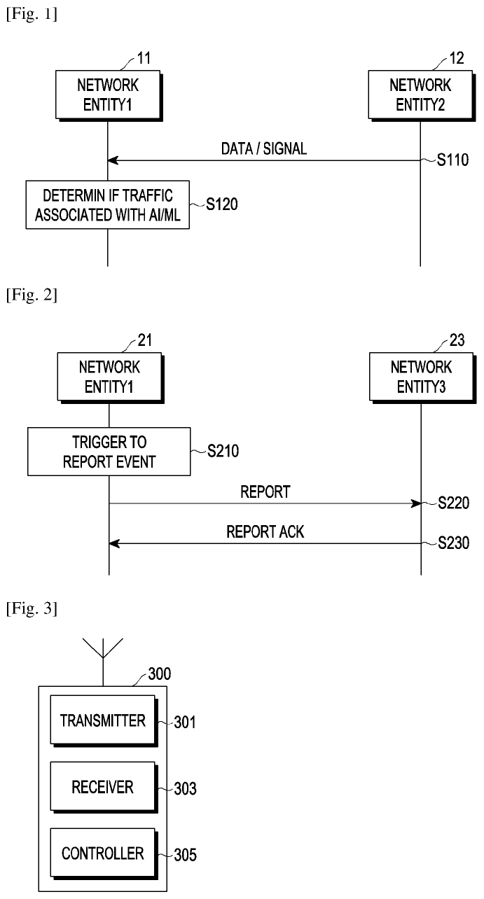

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure are described in detail with reference to the accompanying drawings. When determined to make the subject matter of the disclosure unclear, the detailed description of the related functions or configurations in the embodiments of the disclosure may be skipped. The terms as used herein are defined considering the functions in the disclosure and may be replaced with other terms according to the intention or practice of the user or operator. Therefore, the terms should be defined based on the overall disclosure.

For the same reasons, some elements may be exaggerated or schematically shown. The size of each element does not necessarily reflect the real size of the element. The same reference numeral is used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the disclosure. The disclosure is defined only by the appended claims.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit or part” means a software element or a hardware element such as a field-programmable gate array (FPGA) or an application specific integrated circuit (ASIC). A “unit” or “part” may be configured to play a certain role. However, a “unit” is not limited to software or hardware. A “unit” may be configured in a storage medium that may be addressed or may be configured to execute one or more processors. Accordingly, as an example, a “unit” includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the “units” may be combined into smaller numbers of components and “units” or further separated into additional components and “units.” Further, the components and “units” may be implemented to execute one or more CPUs in a device or secure multimedia card. According to embodiments, a “ . . . unit” may include one or more processors and/or devices.

For ease of description, some of the terms or names defined in the 3rd generation partnership project long term evolution (3GPP)-based communication standards (e.g., 5G, NR, LTE, or similar system standards) may be used. However, the disclosure is not limited by such terms and names and may be likewise applicable to systems conforming to other standards.

As used herein, terms for identifying access nodes, terms denoting network entities, terms denoting messages, terms denoting inter-network entity interfaces, and terms denoting various pieces of identification information are provided as an example for ease of description. Thus, the disclosure is not limited to the terms, and the terms may be replaced with other terms denoting objects with equivalent technical meanings.

In various embodiments of the disclosure, the terminal may be various types of electronic devices, such as a user equipment (UE), a mobile station (MS), a cellular phone, and a smartphone. Hereinafter, an example in which the terminal is a UE is described below.

The description of embodiments of the disclosure focuses primarily on the radio access network, new RAN (NR), and the core network, packet core (5G system, or 5G core network, or NG core, or next generation core), which are specified by the 3rd generation partnership (3GPP) which is a mobile communication standardization organization. However, the subject matter of the disclosure, or slight changes thereto, may also be applicable to other communication systems that share similar technical backgrounds without departing from the scope of the disclosure, which would readily be appreciated by one of ordinary skill in the art.

The skilled person will appreciate that the present disclosure is not limited to the specific examples disclosed herein. For example:

The techniques disclosed herein are not limited to 3GPP 5G.

One or more entities in the examples disclosed herein may be replaced with one or more alternative entities performing equivalent or corresponding functions, processes or operations.

One or more of the messages in the examples disclosed herein may be replaced with one or more alternative messages, signals or other type of information carriers that communicate equivalent or corresponding information.

One or more further elements, entities and/or messages may be added to the examples disclosed herein.

One or more non-essential elements, entities and/or messages may be omitted in various embodiments.

The functions, processes or operations of a particular entity in one example may be divided between two or more separate entities in an alternative example.

The functions, processes or operations of two or more separate entities in one example may be performed by a single entity in an alternative example.

Information carried by a particular message in one example may be carried by two or more separate messages in an alternative example.

Information carried by two or more separate messages in one example may be carried by a single message in an alternative example.

The order in which operations are performed may be modified, if possible, in alternative examples.

The transmission of information between network entities is not limited to the specific form, type and/or order of messages described in relation to the examples disclosed herein.

Various embodiments of the present disclosure may be provided in the form of an apparatus/device/network entity configured to perform one or more defined network functions and/or a method therefor. Such an apparatus/device/network entity may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). Various embodiments of the present disclosure may be provided in the form of a system (e.g., a network) comprising one or more such apparatuses/devices/network entities, and/or a method therefor.

It will be appreciated that examples of the present disclosure may be realized in the form of hardware, software or a combination of hardware and software. Various embodiments of the present disclosure may provide a computer program comprising instructions or code which, when executed, implement a method, system and/or apparatus in accordance with any aspect, claim, example and/or embodiment disclosed herein. Certain embodiments of the present disclosure provide a machine-readable storage storing such a program.

As described in TS 22.261, the AI/ML operation types may be categorised into three types: model splitting, model sharing, and distributed/federated learning. The requirements, frequency and volume of data transmission may differ for different AI/ML processing phrases and/or operation types. Furthermore, operators may also apply various charging rules for different AI/ML traffic. For example, operators may deploy different charging rates or policies for AI/ML traffic data compared to other traffic/data, and even different charging rates for different types of AI/ML traffic (i.e., different AI/ML operations, such as AI/ML model training and AI/ML inference). Currently, the 5G core (5GC) is not aware of the AI/ML traffic/operation.

In Clause 7.10 (“KPIs for AI/ML model transfer in 5GS”) of TS 22.261, different KPIs are identified for AI/ML operations.

Considering the above issues, certain embodiments of the present disclosure provide apparatus, system(s) and method(s) to notify the 5GC (or a network entity) about the AI/ML operation (or AI/ML traffic), and, in various embodiments, notify the 5GC of the type or (processing) phase of the AI/ML operation. The 5CG (e.g. UPF) may then take the AI/ML operation or traffic information into account for handling issues such as data congestion, traffic routing, charging issues, traffic steering, etc.

According to certain embodiments of the present disclosure, any message and/or data packets associated with the AI/ML operation are defined as the AI/ML traffic. The 5GC distinguishes the AI/ML traffic and other types of traffic.

According to certain embodiments of the present disclosure, considering the operation of AI/ML, the AI/ML processing may include two phases: model training and inference (it is not excluded that the AI/ML work may include other phases, but for various embodiments herein the model training phase and the inference phase of AI/ML work are considered as examples). Between the model training stage and the inference stage, the data volume, the packet error rate, the delay tolerance etc., might be significantly different. For example, during the model training phase, transmission of the AI/ML model may result in high data volume; however, the end-to-end delay is more tolerable. Different rules or policies might be deployed to these two phases by the 5GC.

Therefore, according to certain embodiments of the present disclosure, examples of which will be described above, AI/ML traffic (or (data) packets associated with AI/ML) may be defined based on the nature of AI/ML processing phases, that is, data for model training and inference traffic.

As described in TS 22.261, it is expected that the 5GC will at least support the following three types of AI/ML operations in Release 18:
AI/ML operation splitting between AI/ML endpoints
AI/ML model/data distribution and sharing over 5G system
Distributed/Federated Learning (FL) over 5G system

The characteristics of each AI/ML operation type may be different. For example, in operation type a), the privacy-sensitive and delay-sensitive parts are at the end device (e.g., a UE); therefore, the AI/ML traffic in this mode Packet Delay Budget is relatively high. For the operation type b), the AI/ML models do not pre-load all candidate AI/ML models on board; and the model can be distributed from an NW endpoint and downloaded by the end devices when they need it to adapt to the changed AI/ML tasks and environments. Therefore, the data volume operation type b) might be high. In operation type c), the AI/ML model training (and inference) is carried out by multiple end users/devices and the cloud server jointly; therefore, the data transmission may not require high reliability but a large payload size.

Therefore, according to certain embodiments of the present disclosure, the AI/ML traffic (or (data) packets associated with AI/ML) may be categorised based on the AI/ML operation types. Although operation types a), b) and c) are given above, embodiments of the present disclosure are not limited to such and other AI/ML operation types may be taken into account, as desired.

Above, model training and inference are indicated as a (processing) phase of AI/ML, while a), b) and c) are indicated as types of AI/ML operation. For ease of reference, the phases of AI/ML may also be regarded as a type of AI/ML operation, such that the term “type of AI/ML operation”, or the like, may refer to (or include) model training, inference, type a), type b) and/or type c). For example, the skilled person would understand how inference may be regarded as a type of AI/ML operation. The present disclosure will refer to phases (e.g., processing phases) of an AI/ML operation and to types of an AI/ML operation separately, and it will also be intended (unless explained otherwise) that a processing phase of an AI/ML operation may be regarded as a type of an AI/ML operation.

Herein, in various embodiments traffic associated with an AI/ML operation may be AI/ML traffic.

FIG. 1 illustrates a representation of a call flow according to various embodiments of the present disclosure.

FIG. 1 illustrates interaction between a first network entity 11 and a second network entity 12.

In various embodiments, the first network entity 11 is a user plane function (UPF) and/or the second network entity 12 is a UE or an application (e.g., an application executed at a network entity or node). However, the first network entity 11 and the second network entity 12 are not limited to this. The first network entity 11 may be any 5GC network function (NF), i.e. UPF, session management function (SMF), network data analytics function (NWDAF), application function (AF), application, user equipment (UE), new NFs to support AI/ML operation etc. The second network entity 12 may also be any 5GC NF, i.e. UPF, AF, application, SMF, NWDAF, new NFs to support AI/ML operation etc. In various embodiments, the first network entity 11 and the second network entity 12 may be included in a communication network, e.g., a 5G NR communications network.

In operation S110, the second network entity 12 transmits data (or a signal, or data which is a signal) to the first network entity. In various embodiments, the data may relate to an AI/ML operation, may indicate a future AI/ML operation, may request establishment or modification of a protocol data unit (PDU) session for AI/ML operation, may implicitly relate to an AI/ML operation, etc. The data is not limited to being packet data, but may be control information, signalling data etc.

In operation S120, after receiving the data (or the signal) from the second network entity 12, the first network entity 11 determines, based on one or more characteristics of the received data, whether traffic from the second network entity is or will be associated with an AI/ML operation (e.g., is AI/ML traffic). In certain embodiments, the one or more characteristics of the received data includes one or more of: the data itself (or information included within the data), data volume, a time pattern (of the data), and control/configuration information (for example, a 5G quality of service (QoS) identifier (5QI)). For example, via or based on the one or more characteristics, the first network entity 11 may detect that the data (or the signal) is associated with AI/ML operation or AI/ML traffic, in which case the first network entity 11 may determine that the traffic from the second network entity 12 is associated with an AI/ML operation. In another example, via or based on the one or more characteristics, the first network entity 11 may identify information, e.g., in the data, which indicates that traffic from the second network entity 12 is, or may later be, associated with an AI/ML operation. In yet another example, via or based on the one or more characteristics, the first network entity 11 may determine that it is implicit that traffic from the second network entity 12 is or will be associated with an AI/ML operation. In other words, by various methods in accordance with various embodiments described herein, the first network entity 11, which may be a 5G NF, may determine that traffic from (or to) the second network entity 12 is, or will be (for example, in the sense of traffic in a PDU session which is to be established), traffic associated with an AI/ML operation (i.e., AI/ML traffic).

Further, in various embodiments the first network entity 11 may determine a phase (e.g., a processing phase) and/or a type (e.g., an operation type) of the AI/ML operation or the AI/ML traffic.

In various examples, the first network entity 11 may perform one or more operations to assist performance of the AI/ML operation, based on the traffic being associated with the AI/ML operation or with a type of a phase of the AI/ML operation. That is, by monitoring the traffic from the second network entity 12 and determining that the traffic is associated with the AI/ML operation (or with a type or phase of the AI/ML operation), the first network entity 11 may perform the one or more operations based on the traffic or the monitoring of the traffic, such as based on the traffic being associated with the AI/ML operation etc.

FIG. 2 illustrates a representation of a call flow according to various embodiments of the present disclosure.

FIG. 2 illustrates interaction between a first network entity 21 and a third network entity 23. In various embodiments, the first network entity 21 is a user plane function (UPF) and/or the third network entity 23 is a session management function (SMF). However, the first network entity 21 and the third network entity 23 are not limited to this. The first network entity 21 may be any 5GC network function (NF), i.e. UPF, session management function (SMF), network data analytics function (NWDAF), application function (AF), application, user equipment (UE), new NFs to support AI/ML operation etc. The third network entity 23 may also be any 5GC NF, i.e. UPF, UE, AF, application, NWDAF, new NFs to support AI/ML operation etc. The first network entity 21 and the third network entity 23 may be included in a communication network, e.g., a 5G NR communications network. In various embodiments, the first network entity 21 is the first network entity 11 of FIG. 1.

In operation S210, the first network entity 21 may detect a trigger to report an event. The event may be that traffic from a second network entity (not shown), for example the second network entity 12 of FIG. 1, is or will be associated with an AI/ML operation. The trigger may be the determining, by the first network entity 21, that the traffic from the second network entity is or will be associated with the AI/ML operation. For example, the outcome of operation S120 of FIG. 1 may be that the first network entity 21 determines that traffic from the second network entity is or will be associated with an AI/ML operation, and this result triggers the first network entity 21 to report the event to the third network entity 23.

In operation S220, the first network entity 21 may transmit information indicating the traffic from the second network entity will be or is associated with the AI/ML operation to the third network entity 23. That is, the first network entity 21 may report this result or event to the third network entity 23. In various embodiments, this reporting is optional.

In various embodiments, the first network entity 21 is a UPF and the third network entity 23 is a SMF, and the UPF transmits a N4 session report message to the SMF to report the event (where N4 interface connects the UPF to the SMF); for example, to report that AI/ML traffic is detected, AI/ML model training or inference data is detected, data packets for a specific AI/ML operation type are detected, the second network entity requests establishment of a PDU session to be used for AI/ML traffic etc.

In operation 230, the third network entity 23 transmits an acknowledgement (ACK) of the report from the first network entity 21.

In various embodiments where the report was via or included in a N4 session report, the third network entity 23 (e.g., SMF) may identify the N4 session context based on the received N4 Session ID and apply the reported information for the corresponding PDU Session. Additionally, the SMF responds, to the UPF, with an N4 session report ACK message.

In the following, the example of the first network entity being a UPF, the second network entity being a UE and the third network entity being a SMF is used on occasion; however, the present disclosure is not limited to this—this example (i.e., reference to UPF, UE and SMF) is used by way of example only to illustrate the concepts disclosed herein. It will be appreciated that each of the first network entity, the second network entity and the third network entity may be any NF, for example: a UPF, an AF a SMF, a UE, a NWDAF, a new NF to support AI/ML operation etc. Furthermore, while parts of the following refers to the UPF (or first network entity) and the SMF (or third network entity) separately, the present disclosure also considers and includes the case where UPF and SMF are regarded together as part of the 5GC, in which case the described separate behaviours of the UPF and the SMF should be considered together as behaviours of the 5GC—in other words, various embodiments consider the first network entity and the third network entity to be implemented together in a single network entity.

Explicit Indication to the 5GC about AI/ML Traffic

According to certain embodiments of the present disclosure, the AI/ML traffic or operation might be explicitly indicated to the 5GC or any network entity or NF (i.e. the UPF, session management function (SMF), etc.). For example, the data or signal transmitted by a second network entity (such as second network entity 12 of FIG. 1) to a first network entity (such as first network entity 11 of FIG. 1) may include a specific indicator, or specific information, which indicates to the first network entity that the traffic from the second network entity will be, or is, associated with an AI/ML operation (e.g., the traffic is AI/ML traffic). In various embodiments, the first network entity may report this result to a third network entity, such as the third network entity (such as the third network entity 23 of FIG. 2), e.g., via a process such as shown in FIG. 2. Accordingly, the 5GC is informed that (some) traffic from the second network entity, which may be a UE, is associated (or will be associated, in the case of future traffic) with an AI/ML operation.

The information may, in various embodiments, allow the first network entity to determine (or identify, or detect) a type and/or a phase of the AI/ML operation, for example in accordance with one of the examples of types of AI/ML operation described above. For example, the first network entity may determine that the AI/ML traffic will be, or is, for a model training operation (processing phase), or for an inference operation (processing phase), or for a type of an operation being an AI/ML operation splitting between AI/ML endpoints.

The information may take the form, or include, a 5G quality of service (QoS) identifier (5QI) transmitted by the second network entity to the first network entity. That is, one or more new 5QIs may be defined for the AI/ML operation types, with a different 5QI indicating a different AI/ML operation type. Alternatively, a new 5QI may be used to indicate an AI/ML operation in general.

The first network entity or third network entity (or other NF) may determine AI/ML traffic or a type of AI/ML operation at the UE (e.g., corresponding to the traffic) by identifying a value of a received 5QI. For example, for a case of a plurality of new 5QIs, each new 5QI may have a value and corresponding QoS characteristics associated with that 5QI. These QoS characteristics may include one or more of resource type, default priority level, packet delay budget, packet error rate, default maximum data burst volume, default averaging window, and example Services. An example of QoS characteristics mapped to a 5QI which generally indicates AI/ML traffic or FL traffic is shown in Table 1:

TABLE 1
Example of standardized 5QI to QoS characteristics mapping

| | | | | | Default | | |
|---|---|---|---|---|---|---|---|
| | | Default | Packet | Packet | Maximum | Default | |
| 5QI | Resource | Priority | Delay | Error | Data Burst | Averaging | Example |
| Value | Type | Level | Budget | Rate | Volume | Window | Services |
| N | GBR/non- | M | X ms | Y | Z bytes/ | 2000 ms/ | AI/ML service/ |
| | GBR/Delay- | | | | N/A | N/A | traffic or |
| | critical | | | | | | FL traffic |
| | GBR | | | | | | |

In various embodiments, the example services may be AI/ML service/traffic and may include the model training and inference data. The example services may also or alternatively be the federated learning traffic. The AI/ML service/traffic may also indicate the data packets for any type of A/ML operation; that is, may indicate a type of the AI/ML operation.

To give some non-limiting examples:
for AI/ML inference: the payload may be up to 1.5 Mbyte, and packet delay budget may be up to 100 milliseconds.

For AI/ML model training related data, i.e. model downloading, depending on a different purpose for the AI/ML model training—i.e. AI/ML model distribution (e.g. model downloading) for image recognition, AI/ML model distribution for speech recognition, real-time media editing with onboard AI inference etc.—the payload could be 138 Mbyte, 80 Mbyte, 64 Mbyte respectively; and the packet delay budget might be varied between 1 second to 3 seconds.

For federated learning (FL) between UE and network server/application function, for different types of FL—i.e. uncompressed federated learning for image recognition, compressed federated learning for image/video processing, data transfer disturbance in multi-agent multi-device ML operations—the parameters/requirements vary: e.g., the payload size for federated learning types may be 132 Mbyte or 10 Mbyte; delay may be 1 second.

In a case of defining or introducing a plurality of new 5QIs for indicating that traffic is or will be associated with an AI/ML operation, the new 5QIs may indicate the different QoS characteristics or requirements for AI/ML data transmission for each AI/ML operation.

In various embodiments, as the data transmission requirements for the AI/ML model training and inference might be different, i.e. the packet delay budget for the modelling training process may be more relaxed than for the inference stage, different 5QIs could be identified for the two processing phrases, correspondingly. The packets could be the data and/or the messages for model training and inference. A non-limiting example is shown in Table 2:

TABLE 2
Example of standardized 5QI to QoS characteristics mapping

| | | | | | Default | | |
|---|---|---|---|---|---|---|---|
| | | Default | Packet | Packet | Maximum | Default | |
| 5QI | Resource | Priority | Delay | Error | Data Burst | Averaging | Example |
| Value | Type | Level | Budget | Rate | Volume | Window | Services |
| N1 | GBR/non- | M1 | X1 ms | Y1 | Z1 bytes/ | 2000 ms/ | AI/ML model |
| | GBR/Delay- | | | | N/A | N/A | training |
| | critical | | | | | | |
| | GBR | | | | | | |
| N2 | GBR/non- | M2 | X2 ms | Y2 | Z2 bytes/ | 2000 ms/ | AI/ML |
| | GBR/Delay- | | | | N/A | N/A | inference |
| | critical | | | | | | |
| | GBR | | | | | | |

Similarly, in various embodiments, the QoS characteristics for different AI/ML operation types may also be different. New 5QIs could be introduced to present the corresponding QoS characteristics. It will be recalled that the operation types include but are not limited to:
AI/ML Operation Splitting Between AI/ML Endpoints (Split AI/ML Operation)
AI/ML model/data distribution and sharing over 5G system (AI/ML model distribution and sharing)
Distributed/Federated Learning Over 5G System

Additionally, in various embodiments, for the operation type of Distributed/Federated Learning over 5G system, more than one new 5QI(s) might be introduced. For example, different 5QIs indicate different types of federated learning, which may include but are not limited to (this also applies to other solutions/example in the present disclosure):
Uncompressed federated learning for image recognition
Compressed federated learning for image/video processing
Data transfer disturbance in multi-agent multi-device ML operations

A non-limiting example of new 5QIs for these operation types is shown in Table 3:

TABLE 3
Example of standardized 5QI to QoS characteristics mapping

| | | | | | Default | | |
|---|---|---|---|---|---|---|---|
| | | Default | Packet | Packet | Maximum | Default | |
| 5QI | Resource | Priority | Delay | Error | Data Burst | Averaging | |
| Value | Type | Level | Budget | Rate | Volume | Window | Example Services |
| N3 | GBR/ | M3 | X3 ms | Y3 | Z3 bytes/ | 2000 ms/ | Split AI/ML |
| | non-GBR/ | | | | N/A | N/A | operation |
| | Delay- | | | | | | |
| | critical | | | | | | |
| | GBR | | | | | | |
| N4 | GBR/ | M4 | X4 ms | Y4 | Z4 bytes/ | 2000 ms/ | AI/ML model |
| | non-GBR/ | | | | N/A | N/A | distribution and |
| | Delay- | | | | | | sharing |
| | critical | | | | | | |
| | GBR | | | | | | |
| N5 | GBR/ | M5 | X5 ms | Y5 | Z5 bytes/ | 2000 ms/ | Distributed/ |
| | non-GBR/ | | | | N/A | N/A | Federated |
| | Delay- | | | | | | Learning |
| | critical | | | | | | |
| | GBR | | | | | | |

Of course, as mentioned earlier, AI/ML model training and inference may be considered AI/ML operation types for ease of reference, and so, in an example, Tables 2 and 3 may be combined to provide 5QIs N1 to N5, for use in indicating a type of AI/ML operation or phase to the UPF or 5GC or other NF.

In various embodiments, upon receiving the 5QI value or identifying the 5QI value via communication with the first network entity, the third network entity may determine one or more QoS characteristics corresponding to the AI/ML operation based on the 5QI value. For example, the third network entity may determine a set of one or more QoS characteristics (such as one or more of resource type, default priority level, packet delay budget, packet error rate, default maximum data burst volume, default averaging window, and/or example services) corresponding to the type or the phase of the AI/ML operation/traffic from among a plurality of sets of QoS characteristic each corresponding to one of a plurality of different types of AI/ML operation. For example, the third network entity can check a received 5QI value against a stored table, such as one or more of Tables 1 to 3, to identify corresponding QoS characteristics.

In an example, a 5QI may represent the QoS requirements for AI/ML model training, including model downloading (e.g. such as in model distribution). Here, in one example, the resource type may be non-GBR, the default averaging window may be N/A, and a default maximum data burst volume may be N/A, and, optionally, the packet error rate (corresponding to “Reliability” in Table 7.10-2 of TS 22.621)) may be 10⁻³ (referring to “Reliability2 value 99.9% given in Table 7.10-1 of TS 22.621). The first network entity, e.g. UPF, may determine the 5QI corresponding to AI/ML traffic that is from the second network entity (the first network entity having determined that this traffic is associated with an AI/ML operation or with a type or a phase of an AI/ML operation) as the aforementioned 5QI corresponding to the QoS requirements for AI/ML model training including model downloading. The first network entity may then process the traffic from the second network entity according to the QoS requirements corresponding to the determined 5QI value.

In another example, the first network entity may determined a 5QI representing QoS requirements for split AI/ML inference operation, such as relating to DL split AI/ML image recognition. Here, for instance, the resource type may be delay-critical GBR and the default averaging window may be 2000 ms, and, optionally, the packet error rate (corresponding to “Reliability” in Table 7.10-1 of TS 22.621)) may be 10⁻⁵ (referring to “Reliability” value 99.999% given in Table 7.10-1 of TS 22.621). If the first network entity determines the 5QI corresponding to traffic from the second network entity to be this 5QI, the first network entity may process the traffic according to the corresponding QoS requirements.

In another example, the first network entity may determine a 5QI representing QoS requirements for split AI/ML inference operation, such as relating to UL split AI/ML image recognition. Here, for instance, the resource type may be delay-critical GBR and the default averaging window may be 2000 ms, and, optionally, the packet error rate (corresponding to “Reliability” in Table 7.10-1 of TS 22.621)) may be 10⁻³ (referring to “Reliability” value 99.9% given in Table 7.10-1 of TS 22.621). If the first network entity determines the 5QI corresponding to traffic from the second network entity to be this 5QI, the first network entity may process the traffic according to the corresponding QoS requirements.

Implicit Indication to the 5GC about the AI/ML Traffic

According to certain embodiments of the present disclosure, the AI/ML traffic or operation might be implicitly indicated to the 5GC or any NF (e.g., the UPF, session management function (SMF), etc.). That is, the 5GC may determine whether the traffic (from another network entity, such as a UE) is associated with AI/ML without explicit indication. It will be appreciated that this may contrast to the embodiments disclosed above where an explicit indication is transmitted to the UPF, for example using a new 5QI.

According to various embodiments, implicit indication that traffic from the second network entity is, or will be, associated with an AI/ML operation is achieved through reserving and/or predefining specific information for use by AI/ML operations. For example, operators and service providers may reserve one or more of the following information for AI/ML:
CN Tunnel Info
Network Instance
Application Identifier

Once the predefined/standardised value is detected by the 5GC (e.g., the first network entity, a UPF etc.), the 5GC is aware of the transmission of AI/ML traffic. That is, for example, the first network entity may determine that data received from the second network entity, such as a UE, includes the predefined or standardised value, thereby determining that traffic from the UE is, or will be, associated with an AI/ML operation. Following this, the first network entity may report, to the third network entity (e.g., SMF), that the traffic is associated with the AI/ML operation.

In certain embodiments, the first and third network entities (e.g., the UPF and SMF) have the same knowledge of the reserved/predefined specific information. For example, the specific information may be associated with control/configuration information (for example, 5QI) known or accessible to both the first and third network entities. For example, the specific information may be defined in a technical standard, or a SMF may transmit (or otherwise indicate) the specific information to a UPF.

For example, according to TS 23.501, a SMF informs an UPF about the reserved/predefined information. TS 23.501 describes that the SMF is responsible for in-structing the UPF about how to detect user data traffic belonging to a packet detection rule (PDR) and that the other parameters provided within a PDR describe how the UPF shall treat a packet that matches the detection information. According to TS 23.501, detection information may include: CN tunnel info; Network instance; QFI; IP packet filter set as defined in clause 5.7.6.2 of TS 23.501/ethernet packet filter Set as defined in clause 5.7.6.3 of TS 23.501; and application identifier (the application identifier is an index to a set of application detection rules configured in UPF). According to certain embodiments of the present disclosure, the UPF (i.e., first network entity) may determine whether the information included in the data packets matches the detection information that has been indicated by the SMF (i.e., third network entity). If it matches, the UPF determines it is AI/ML traffic and may report this to the SMF.

### Monitoring and Reporting of AI/ML Traffic Via N4 Session

Referring to Section 4.4.2 (“N4 Reporting Procedures”) of TS 23.502, it is described that the N4 reporting procedure is used by the UPF to report events to the SMF.

Accordingly, in certain embodiments of the present disclosure, the UPF is allowed to report the detection of AI/ML traffic to the SMF. Therefore, the SMF will be aware of the transmission of the AI/ML traffic. An example of this is illustrated in FIG. 2, described above.

Referring to Clause 5.8.2.4 of TS 23.501, it is described that the SMF controls the traffic detection at the UPF by providing detection information for every packet detection rule (PDR). Therefore, based on the information provided in PDR—for example, this may be a new 5QI for AI/ML traffic/operation in accordance with various embodiments of the present disclosure as described above and/or other information in the PDR, the UPF can determine/monitor whether the traffic (from a UE, or second network entity) is AI/ML traffic or AI/ML operation.

Furthermore, if the AI/ML traffic-related information can indicate the AI/ML processing phases and/or AI/ML operation types (e.g., in accordance with a method described herein), the UPF may report the corresponding detection results to the SMF.

In various embodiments, new reporting case(s) and/or reporting triggers are introduced for the AI/ML traffic reporting. In various embodiments, existing reporting case(s) and/or reporting triggers are re-used, thereby introducing the AI/ML traffic related information/indication to the existing reporting case(s)/reporting triggers—accordingly, the UPF may detect the AI/ML traffic using implicit information (that is, through re-use of the existing reporting case(s) and/or reporting triggers, the UPF may implicitly detect the AI/ML traffic, with reference here to the discussion of the “Implicit Indication to the 5GC about the AI/ML traffic” above). For example:

The UPF detects the AI/ML traffic based on the detection of protocol data unit (PDU) Session Inactivity (for a specified period). If the AI/ML traffic is detected, UPF will report this to SMF. The detection may be a combination of the following:

The inactivity timer(s), PDU session activity/inactivity pattern for different time etc. is configured;
there is no data transferred for a period specified by the Inactivity Timer/pattern;
data transmission is resumed/available during the PDU session activity period/pattern;
if one or more of the above criteria (activity/inactivity timer/pattern) is configured for a group of UEs, or the PDU session activity/inactivity are detected (the detection may happen to one than more PDU sessions for a group of UEs), the UPF may determine traffic is for FL.

UPF detects the AI/ML traffic based on the detection of time-dependent QoS. That is, for the PDU session, the QoS requirements/measurement varies against time. From time 1-2, the QoS parameters are set A; but from time 2-3, the QoS parameters are set B.

UPF detects the AI/ML traffic based on the detection of the traffic/data volume, the data volume within a certain period, or the characteristics of the data packets. For example, for model training, the UE may need to download the model within 1-3s, and the total packet sizes may be up to more than 536 Mbyte. For example, for AI/ML inference, the end-to-end latency might be 2 ms, 12 ms, 100 ms with a high data rate. For example, for a model splitting type operation, smaller size models could be shared frequently, as it may not be convenient to share or distribute very large models frequently.

If the above detections are triggered, the UPF will report about detecting AI/ML traffic this to the SMF. The UPF may also report, to the SMF, which operation type the AI/ML traffic belongs to, i.e. federated learning, or, if considered distinct to operation type, which operation phase the AI/ML traffic belongs to (i.e. model training/downloading or inference).

In an example, a procedure is as follows:
Step 1: The UPF may detect the AI/ML traffic. The UPF may trigger the reporting of the reported event. For example, AI/ML traffic is detected, AI/ML model training or inference data is detected (i.e., AI/ML phase), or the data packets for the corresponding AI/ML operation type are detected.
Step 2: The UPF may, optionally, send/transmit an N4 session report message to the SMF. In an example, the message includes the corresponding information related to AI/ML in Step 1).
Step 3: The SMF may, optionally, identify the N4 session context based on the received N4 session ID and may apply the reported information for the corresponding PDU Session. In a further example, the SMF may, optionally, respond with an N4 session report ACK message.

Examples above refer to a case of a UPF and a SMF. It will be appreciated that this is in view of reference to the N4 interface, and that the concepts could also be extended to cases where the UPF is replaced by another network entity (e.g., another NF, such as one of those referred to in the present disclosure) and the SMF is replaced by another network entity (e.g., another NF, such as one of those referred to in the present disclosure).

### Indicating AI/ML Traffic During PDU Session Establishment/Modification

In an AI/ML operation, a very large amount of data may be transmitted within a certain time for AI/ML model exchange and inference. At other times, no significant AI/ML traffic might be transmitted. And in some use cases, the AI/ML model exchange or inference may not happen frequently.

According to certain embodiments of the present disclosure, PDU session(s) which are only for AI/ML traffic may be established. For example, by isolating the AI/ML traffic from other types of traffic in one or more PDU sessions, the 5GC may inactivate the one or more PDU sessions while there is no data to be transmitted, configure proper rules for the one or more PDU sessions etc.

In various embodiments, the AI/ML traffic and the traffic for other types of services are transferred using the same PDU session.

Therefore, in certain embodiments of the present disclosure, the data transmitted by the second network entity (such as second network entity 12 of FIG. 1) to the first network entity (such as first network entity 11 of FIG. 1) therefore indicates, to the first network entity, that a (potentially yet to be established) PDU session will be used for AI/ML traffic (i.e., for traffic associated with an AI/ML operation), and (optionally) will only be used for AI/ML traffic. Accordingly, the first network entity may determine that the traffic from the second network entity, or at least that future traffic from the second network entity, is associated with an AI/ML operation or is AI/ML traffic.

To inform the 5GC (for example, the UPF or first network entity) of the potential traffic/usage of the corresponding PDU session, the UE (or second network entity) may send the indication to the 5GC during PDU session establishment/modification. The indication may inform the 5GC of one or more of the following
that the PDU session will be used for AI/ML traffic only,
that the PDU session will be used for AI/ML traffic (other traffic is not excluded),
whether the traffic to be transmitted is for model training or inference, and/or
which type of AI/ML operation generates the AI/ML traffic.

Some non-limiting examples of the indication are:
a new information element (IE) in a PDU session establishment/modification request message;
a bit in 5GSM capability IE (e.g., a spare bit could be used);
a bit in 5GMM capability IE (e.g., a spare bit could be used);
a new message type may be introduced to indicate that the PDU session is used for the AI/ML services/operation;
Reserved or predefined PDU session ID(s) for AI/ML PDU session may be used. The AI/ML PDU session indicates the PDU session that carries AI/ML traffic.

FIG. 3 illustrates a block diagram illustrating an exemplary network entity 300 (or electronic device 300, or network node 300 etc.) that may be used in various embodiments of the present disclosure.

For example, a first network entity, a second network entity, a third network entity, a UPF, a SMF, a NWDAF, a UE and/or another NF (such as a new NF introduced to support AI/ML traffic/operation) may be implemented by or comprise network entity 300 (or be in combination with a network entity 3000) such as illustrated in FIG. 3. The network entity 300 comprises a controller 305 (or at least one processor) and at least one of a transmitter 301, a receiver 303, or a transceiver (not shown).

For example, referring to FIGS. 1 and/or 2 for illustrative purposes, in a case where the first network entity 11, 21 is implemented using network entity 300: receiver 303 may be used in the process of receiving data or a signal from the second network entity 22; controller 305 may be used in the process of determining based on one or more characteristics of the data, that traffic from the second network entity will be or is associated with an AI/ML operation; and transmitter 301 may be used in the process of transmitting information indicating the traffic will be or is associated with the AI/ML operation to a third network entity 23. In a case where the second network entity 22 is implemented using network entity 300: transmitter 301 may be used in the process of transmitting a signal or data to the first network entity 11, where the data/signal may include or be associated with one or more characteristics indicating that traffic from the second network entity will be or is associated with an artificial intelligence/machine learning (AI/ML) operation. In a case where the third network entity 23 is implemented using network entity 300: receiver 301 may be used in the process of receiving, from the first network entity 21, information indicating traffic, from a second network entity, will be or is associated with an artificial intelligence/machine learning (AI/ML) operation.

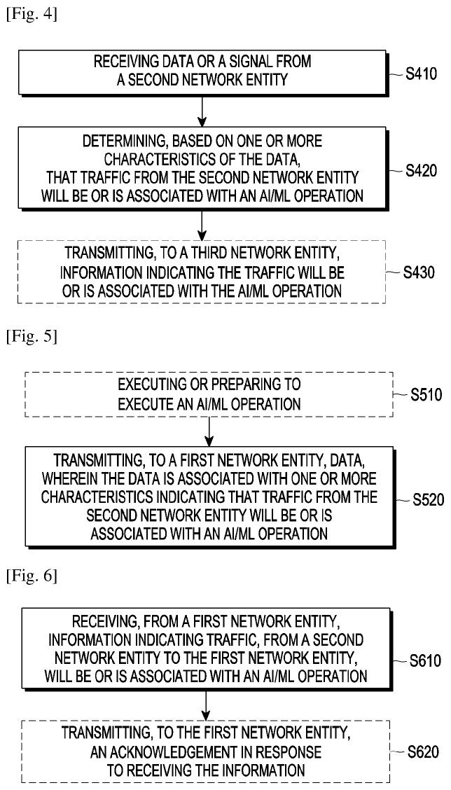

FIG. 4 illustrates a flow diagram of a method of a first network entity according to various embodiments of the present disclosure.

In S410, a first network entity receives data (or a signal) from a second network entity.

In S420, the first network entity determines, based on one or more characteristics of the data, that traffic from the second network entity will be or is associated with an AI/ML operation.

Operation S430 is optional (depicted by dashed lines in the figure, in this instance). In S430, the first network entity transmits, to a third network entity, information indicating the traffic will be or is associated with the AI/ML operation. For example, the information may be transmitted in an N4 session report message.

FIG. 5 illustrates a flow diagram of a method of a second network entity according to various embodiments of the present disclosure.

Operation S510 is optional (depicted by dashed lines in the figure, in this instance). In S510, the second network entity executes or prepares to execute (that is, is aware that it will be executing in the future) an AI/ML operation.

In operation S520, the second network entity transmits, to a first network entity, data, wherein the data is associated with one or more characteristics indicating that traffic from the second network entity will be or is associated with an AI/ML operation.

FIG. 6 illustrates a flow diagram of a method of a third network entity according to various embodiments of the present disclosure.

In operation S610, the third network entity receives, from a first network entity, information indicating traffic, from a second network entity to the first network entity, will be or is associated with an AI/ML operation. For example, the information may be received in a N4 session report message.

Operation S620 is optional (depicted by dashed lines in the figure, in this instance). In S620, the third network entity transmits, to the first network entity, an acknowledgement in response to receiving the information. For example, the response may be an N4 session report ACK.

It will be appreciated that, in various embodiments, in the methods of FIG. 4, FIG. 5 and/or FIG. 6: the first network entity may be in accordance with any first network entity (e.g., a UPF, SMF, UE, application, NWDAF, AMF, PCF, UDM, NEF, NRF, AUSF, NSSF, UDR, AF or new NF for supporting or implementing AI/ML) described above; and/or that the second network entity may be in accordance with any second network entity (e.g., a UE, application, SMF, UPF, NWDAF, AMF, PCF, UDM, NEF, NRF, AUSF, NSSF, UDR, AF or new NF for supporting or implementing AI/ML) described above; and/or the third network entity may be in accordance with any third network entity (e.g., a SMF, UPF, UE, NWDAF, AMF, PCF, UDM, NEF, NRF, AUSF, NSSF, UDR, AF or new NF for supporting or implementing AI/ML) described above.

All of the features disclosed in this specification (including any accompanying claims, abstract and drawings), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this specification (including any accompanying claims, abstract and drawings), or to any novel one, or any novel combination, of the steps of any method or process so disclosed.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement various embodiments of the present disclosure. Accordingly, various embodiments provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

Although the present disclosure has been described with various embodiments, various changes and modifications may be suggested to one skilled in the art. It is intended that the present disclosure encompass such changes and modifications as fall within the scope of the appended claims.

### ACRONYMS AND DEFINITIONS

3GPP 3^{rd} Generation Partnership Project
5G 5^{th} Generation
5GC 5G Core
5GS 5G System
5GSM 5G System Session Management
5GMM 5G System Mobility Management
AF Application Function
AI Artificial Intelligence
AMF Access and Mobility management Function
AS Application Server
ASP Application Service Provider
AUSF Authentication Server Function
DCAF Data Collection Application Function
DNAI Data Network Access Identifier
DNN Data Network Name
DNS Domain Name Server
FQDN Fully Qualified Domain Name
GBR Guaranteed Bit Rate
GPSI Generic Public Subscription Identifier
ID Identity/Identifier
IMEI International Mobile Equipment Identities
IP Internet Protocol
I-SMF Intermediate SMF
ML Machine Learning
MNO Mobile Network Operator
MT Mobile Termination
NAS Non-Access Stratum
NEF Network Exposure Function
NRF Network Repository Function
NSSF Network Slice Selection Function
NW Network
NWDAF Network Data Analytics Function
OS Operating System
OSAPP OS Application
PCF Policy Control Function
PCO Protocol Configuration Options
PDR Packet Detection Rule
PDU Protocol Data Unit
RSD Route Selection Descriptor
SIM Subscriber Identity Module
SLA Service Level Agreement
SM Session Management
SMF Session Management Function
S-NSSAI Single Network Slice Selection Assistance Information
SSC Session and Service Continuity
SUPI Subscription Permanent Identifier
TAI Tracking Area Identity
TE Terminal Equipment
TS Technical Specification
UDM Unified Data Manager
UDR Unified Data Repository
UE User Equipment
UL Uplink
UP User Plane
UPF User Plane Function
URSP UE Route Selection Policy

1-13. (canceled)

14. A method of a user plane function (UPF) included in a communications network, the method comprising:
monitoring traffic from a user equipment (UE); and
based on the traffic associated with an artificial intelligence/machine learning (AI/ML) operation, performing at least one operation to assist performance of the AI/ML operation.

15. The method of claim 14, wherein the AI/ML operation corresponds to one of:
an AI/ML operation splitting between AI/ML endpoints;
an AI/ML model or data distribution and sharing; and
distributed or federated learning.

16. The method of claim 14, wherein performing at least one operation comprises:
performing the at least one operation to assist performance of the AI/ML operation based on monitoring session inactivity related to the traffic, and monitoring traffic volume related to the traffic.

17. The method of claim 14, wherein the at least one operation comprises:
applying a charging rate to traffic associated with the AI/ML operation based on policy set by an operator.

18. The method of claim 14, wherein the at least one operation comprises:
mapping a 5G quality of service (QoS) identifier (5QI) corresponding to the AI/ML operation to QoS characteristics.

19. The method of claim 18, wherein the QoS characteristics comprise one or more of:
a resource type including one of non-guaranteed bit rate (GBR) or delay-critical GBR,
a packet delay budget,
a packet error rate,
a default maximum data burst volume, or
a default averaging window.

20. The method of claim 19, wherein:
the AI/ML operation is AI/ML model downloading, in case that the QoS characteristics comprise: the resource type of the non-GBR, the default maximum data burst volume of not available, and a default averaging window of not available; or
the AI/ML operation is downlink (DL) split AI/ML image recognition, in case that the one or more QoS characteristics comprise: the resource type of the delay-critical GBR.

21. The method of claim 16, further comprising:
reporting an event to a first network entity based on the monitoring of the session inactivity or the monitoring of the traffic volume.

22. The method of claim 21, wherein reporting the event comprises:
transmitting an N4 session report message to the first network entity to report the event; and/or
wherein the event indicates the session inactivity, the traffic volume, the AI/ML operation and/or phase of the AI/ML operation.

23. The method of claim 21, wherein one or more of:
the first network entity is one of a user plane function (UPF), a user equipment (UE), a session management function (SMF), an application function (AF), an application, a network data analytics function (NWDAF), or a network function (NF) configured to support the AI/ML operation;
the communications network is a 5G network; and/or
wherein the first network entity is included in a 5G core (5GC).

24. A user plane function (UPF) entity included in a communication network, the UPF entity comprising:
a transmitter;
a receiver; and
a controller configured to:
monitor traffic from a user equipment (UE); and
based on the traffic associated with an artificial intelligence/machine learning (AI/ML) operation, perform at least one operation to assist performance of the AI/ML operation.

25. The UPF entity of claim 24, wherein the AI/ML operation corresponds to one of:
an AI/ML operation splitting between AI/ML endpoints;
an AI/ML model or data distribution and sharing; and
distributed or federated learning.

26. The UPF entity of claim 24, wherein the controller is further configured to:
perform the at least one operation to assist performance of the AI/ML operation based on monitoring session inactivity related to the traffic, and monitoring traffic volume related to the traffic.

27. The UPF entity of claim 24, wherein the at least one operation comprises:
apply a charging rate to traffic associated with the AI/ML operation based on policy set by an operator.

28. The UPF entity of claim 24, wherein the at least one operation comprises:
map a 5G quality of service (QoS) identifier (5QI) corresponding to the AI/ML operation to QoS characteristics.

29. The UPF entity of claim 28, wherein the QoS characteristics comprise one or more of:
a resource type including one of non-guaranteed bit rate (GBR) or delay-critical GBR,
a packet delay budget,
a packet error rate,
a default maximum data burst volume, or
a default averaging window.

30. The UPF entity of claim 29, wherein:
the AI/ML operation is AI/ML model downloading, in case that the QoS characteristics comprise: the resource type of the non-GBR, the default maximum data burst volume of not available, and a default averaging window of not available; or
the AI/ML operation is downlink (DL) split AI/ML image recognition, in case that the one or more QoS characteristics comprise: the resource type of the delay-critical GBR.

31. The UPF entity of claim 26, wherein the controller is further configured to:
report an event to a first network entity based on the monitoring of the session inactivity or the monitoring of the traffic volume.

32. The UPF entity of claim 31, wherein the controller is further configured to:
transmit an N4 session report message to the first network entity to report the event, and/or
wherein the event indicates the session inactivity, the traffic volume, the AI/ML operation and/or phase of the AI/ML operation.

33. The UPF entity of claim 31, wherein one or more of:
the first network entity is one of a user plane function (UPF), a user equipment (UE), a session management function (SMF), an application function (AF), an application, a network data analytics function (NWDAF), or a network function (NF) configured to support the AI/ML operation;
the communications network is a 5G network; and/or
wherein the first network entity is included in a 5G core (5GC).
